(19) United States
(12) Patent Application Publication
(10) Pub. No.: US 2009/0065338 A1
(43) Pub. Date: Mar. 12, 2009

(54) CIRCUIT BREAKER FOR MOTOR PROTECTION AND/OR LINE PROTECTION

(75) Inventors: Guenter Baujan, Troisdorf (DE); Klaus Dauer, Koblenz (DE); Anke Juelich, Niederkassel (DE)

Correspondence Address: DARBY & DARBY P.C., P.O. BOX 770, Church Street Station, New York, NY, 10008-0770, US

(73) Assignee: Moeller GmbH, Bonn (DE)

(21) Appl. No.: 12/299,589

(22) PCT Filed: Apr. 26, 2007
(86) PCT No.: PCT/EP2007/003668

§ 371 Date: Nov. 4, 2008

(30) Foreign Application Priority Data
May 4, 2006 (DE) 102006020702.5

(51) Int. Cl. H01H 3/08

(52) U.S. Cl. 200/329

(57) ABSTRACT

A manually operated circuit breaker for motor protection and/or line protection includes a basic board including a switching mechanism, a contact device, and a main current path. The switching mechanism includes a switching apparatus and a breaker latching mechanism. The circuit breaker includes a manual actuating device disposed in a housing part protruding from an operating front and configured to activate the switching mechanism via a rotary knob and an actuating shaft disposed perpendicular to the operating front. The circuit breaker includes an electronic control unit module pluggable onto the basic board and configured to be set with at least one control variable for a fault scenario so as to activate the switching mechanism by indicating a settable fault scenario. The electronic control unit is supplied with a voltage from the main current path via the contact device. An actuator unit including an energy storing device is configured to activate the breaker latching mechanism, and a tripping element is configured to respond to a settable fault criterion.

### FIELD OF THE INVENTION

The present invention relates to a manually operated circuit breaker for motor protection and/or line protection. Such circuit breakers comprise essentially a basic board, a manual actuating device, an electronic control unit, an actuator unit and a tripping element. Through the use of a manual actuating device, at least the switching mechanism is activated by means of a rotary knob and of an actuating shaft, whereby the actuating device is accommodated in a housing part that protrudes from the operating front, and the actuating shaft is arranged perpendicular to the operating front. The rotary knob projects forward from the operating front and can preferably be configured so that it can also be locked.

### DESCRIPTION OF RELATED ART

As a motor circuit breaker, circuit breakers are known whose tripping behavior (up to several times the starting current) is adapted to the electric motor to be protected, or which serve as line circuit breakers to protect electric lines or systems against thermal overloads or short-circuit damage. The tripping behavior and thus the use of such circuit breakers are determined by the thermal and short-circuit tripping values.

Examples of modular circuit breakers built according to the modular principle are described in German patent application DE 36 42 719 A1 or in international patent application WO 01-27958 A1. Another motor circuit breaker can also be equipped with replaceable overcurrent tripping modules (Swiss patent specification CH 319019). Here, an operator can install various tripping modules that differ in terms of different current ranges or different time-lag classes.

For safety reasons, it should not be possible to pull out a tripping module when the circuit breaker is in the ON position. In this context, German patent application DE 36 42 719 A1 puts forward a safety device in the form of a flap. The flap has a window through which the actuating rotary knob passes. The window is configured in such a way that the actuating rotary knob extends beyond the edges of the window and locks it so that the tripping module cannot be pulled out of the plugged position. The safety device (the flap) is a part with a very complex design.

German patent application DE 195 15 923 A1 describes a circuit breaker that can be modularly expanded by plugging on additional replaceable modules. The circuit breaker has a prismatic housing part the protrudes towards the operating front, with two connection surfaces and contact surfaces being formed on this housing part perpendicular to the operating front. In this state of the art, the additional modules can be plugged directly onto the circuit breaker, or else they are attached onto a substrate (support rail) separately from the circuit breaker.

A drawback of such and similar circuit breakers is that modular assembly is possible, irrespective of whether the circuit breaker is in the ON position or not.

### PRESENTATION OF THE INVENTION

The invention is based on the objective of allowing a circuit breaker to be assembled modularly with at least one replaceable control unit, whereby, on the one hand, different functional features can be set using the control unit and, on the other hand, a safety function exists so that the replacement can only be effectuated under certain conditions.

This objective is achieved according to the invention essentially by the features of claim 1, while the subordinate claims characterize particularly advantageous refinements of the invention.

The essence of the invention consists in the fact that the electronic control unit is configured as a module that can be plugged onto the basic board and that the source of electric energy that supplies the consumer is looped through the control unit. The control unit also encompasses another protection function for the operation of the consumer protected by the circuit breaker. Furthermore, the control unit (especially in the form of its electronic circuit) draws its voltage and the detection data from the main current path of the circuit breaker. The electronic circuit is the center of the control unit. The parameters of the current flowing through the main current paths are fed to the circuit as input signals and measuring signals via current transformers. Therefore, the control unit is always operational when the circuit breaker of at least one of the downstream consumers is carrying current. Contact means are present so that the control unit can be plugged onto the basic board.

The control unit is set to certain controlled variables for a fault scenario in which the circuit breaker is supposed to switch off. Preferably, an operator can change the settings to different controlled variables by means of rotary knobs accessible from the outside. Primarily the lag time of the switch-off and a fault current that exceeds a given rated current can be prescribed and/or set as the controlled variables. Such fault current criteria are also to be found in international standards (EN 60947) where, for example, tripping times are associated with various groups of rated currents. When a fault occurs, the control unit actuates the switching mechanism via the actuator unit, as a result of which the contacts of the main current paths are opened. The core of the actuator unit is an energy storing device that brings about the accelerated activation of the breaker latching mechanism. The circuit breaker can include a short-circuit instantaneous tripping element that likewise acts upon the switching apparatus via a mechanical operative connection. The circuit breaker with the described basic board forms a basic device with which the customer/operator can prescribe and/or change individual functional features by replacing the control unit and/or the tripping module.

Other individual components can also be plugged into or onto the basic board, or can be assembled with the circuit breaker in some other manner. The circuit breaker according to the invention entails the advantage of a basic device with which functions for a given application can be easily and reliably set or, if necessary, their values can be changed. At the same time, prior to the start of work on the electric installation or on an electric motor that is to be protected, the control unit can be pulled out so that a visible disconnection point is created and the wiring run is safely interrupted.

In a practical manner, the voltage is supplied via current transformers. It is a decisive advantage if the openings for plug-in contacts are configured to be protected from finger touch so that they are safeguarded against accidental touching. Preferably, the tripping element can be additionally equipped with a tripping function in case of an undervoltage.

Moreover, in one embodiment, a blocking device can be provided that is to be activated by the actuation device that is formed on the actuating shaft and that can be activated by turning the actuating shaft. The blocking device blocks the control unit from being pulled out when the circuit breaker is in the ON position. The blocking device consists of a mechanical blocking means that can be acted upon and actuated by the actuating shaft, and mechanical blocking means then blocks or releases the plugging movement of the control unit. One advantage lies in the fact that the control unit is securely blocked against impermissible or unauthorized replacement. The blocking device obstructs access to the control unit that is to be plugged and blocks the movement of the control unit. The blocking takes place autonomously, without a need for additional actuation from the outside by turning the actuating shaft. The blocking ensures a secure fixation of the control unit when the circuit breaker is switched on. In the switched-on state, the control unit cannot be pulled out since it is blocked by the blocking device that has been activated by the actuating rotary knob. The control unit can only be pulled out and replaced when the circuit breaker is switched off.

Preferably, in one embodiment of the circuit breaker, a device can be present to affix a lead seal to a control unit that has been plugged onto the basic board. For purposes of further enhancing the safety, the manual actuating device can be configured so as to be lockable. This means that the rotary knob can be locked in the ON position of the switch by means of a lock. In such an arrangement, it is neither possible to actuate the rotary knob into the ON position nor to remove it.

### BRIEF DESCRIPTION OF THE DRAWINGS

Additional details and advantages can be gleaned from the embodiment below explained on the basis of the FIGURE. The following is shown:

FIG. 1—a schematic depiction of a circuit breaker drawn in the form of a block diagram.

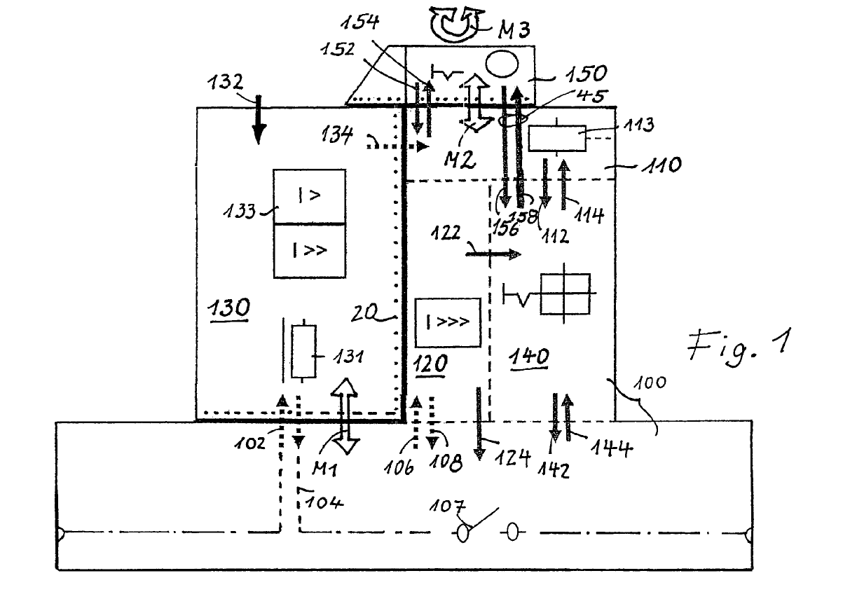

### BEST WAY TO EXECUTE THE INVENTION

The FIGURE relates to a circuit breaker that is part of a switch combination that can be plugged together and whose components are configured as a modular system. The components of the module, insofar as they are of relevance for the present invention, are: the basic board 100 that essentially comprises the contact apparatus 107 and the breaker latching mechanism 140; the tripping module 120; the actuator unit (tensioning unit) 110; the pluggable control unit 130 and the manual actuating device. The control unit 130 can be inserted into the switch housing next to the protruding housing part parallel to the axis of the actuating rotary knob. The mechanical plugging and disconnecting capability is indicated in the FIGURE by means of the broken line 20.

Guiding and connecting elements, not shown here in greater detail, are present, especially contact means (plug-in contacts for 102, 104) to the basic board as well as contact means 134 to the actuator unit 110. The guiding and connecting elements interact with corresponding elements (receiving elements or contact sockets). Between the control unit and the basic board, there is an air break between plug-in contacts and contact sockets. It is advantageous if this air break is visible when the control unit is not plugged in. Input and output contacts, main current paths, which especially can be of the three-phase type, as well as the contact apparatus 107 are all indicated in the basic board 100. In the center of the module arrangement, there is a protruding prismatic housing part having an operating front that is situated opposite from the attachment surface. The attachment surface is situated on the back of the circuit breaker and serves primarily for the attachment onto a support rail.

The above-mentioned housing part essentially comprises a device to be operated manually with an actuating shaft 45 via an actuating rotary knob 150 for purposes of actuating at least one switching mechanism 107 of the circuit breaker in order to open and close line paths 102, 104.

The actuating shaft 45 is arranged perpendicular to the operating front and to the attachment surface (at the back of the circuit breaker). A connection surface for the pluggable control unit is formed on the housing part perpendicular to the operating front. The connection surface has linear guiding elements and connector means or contact means, which are not shown in greater detail here. In particular, a contact 134 consisting of at least one contact pair and leading to the actuator unit 110 is present.

The circuit breaker is actuated at an actuating rotary knob 150 with which the ON and OFF positions can be switched by executing a 90° turn. In the ON position, the switching contacts 107 are closed. From this position, the switching contacts of the circuit breaker can be manually opened by means a first turn of the drive shaft using the actuating rotary knob. The drive shaft releases the breaker latching mechanism in the switch drive mechanism and opens the switching contacts. A brief turn in the opposite direction in order to actuate the breaker latching mechanism is sufficient for the manual switch-off. Turning by a full 90° is not necessary for this purpose. During the automatic switching-off in case of a fault and the opening of the switching contacts, the drive shaft necessarily moves along as well. In the switched-off state of the circuit breaker, when the breaker latching mechanism and switching contacts are open, it is not possible to put the circuit breaker directly into the switched-on state. First, the mechanical energy storing device of the tripping module has to be tensioned. For this purpose, the tripping module is moved out of the OFF position by turning the actuating rotary knob (and the drive shaft) by about 20° to 30° (in other words, in the opposite direction from the ON switching movement).

The individual components can also be plugged into or onto the basic board, or can be assembled with the circuit breaker in some other manner. However, an essential aspect in conjunction with the claimed subject matter is that the control unit 130 and the module of the manual rotary drive 150 can be plugged in. The tripping module 120 is preferably configured to likewise be replaceable, whereby it can be inserted next to the prismatic housing part parallel to the axis of the actuating rotary knob.

The tripping module has plug-in contacts that can be plugged into matching contact sockets on the basic board. It is also essential that the tripping module in the locking state of the locking device can only be inserted up to a point in which an air break is still present, and in particular, visible, between the plug-in contacts and the contact sockets.

1-8. (canceled)

9: A manually operated circuit breaker for motor protection and/or line protection, comprising:
a basic board including a switching mechanism, a contact device, and a main current path, the switching mechanism including a switching apparatus and a breaker latching mechanism;
a manual actuating device disposed in a housing part protruding from an operating front and configured to activate the switching mechanism via a rotary knob and an actuating shaft, the actuating shaft being disposed perpendicular to the operating front;
an electronic control unit module pluggable onto the basic board and configured to be set with at least one control variable for a fault scenario so as to activate the switching mechanism by indicating a settable fault scenario, the electronic control unit being supplied with a voltage from the main current path via the contact device;
an actuator unit including an energy storing device configured to activate the breaker latching mechanism; and
a tripping element configured to respond to a settable fault criterion.

10: The manually operated circuit breaker as recited in claim 9, wherein the voltage is supplied to the electronic control unit via a current transformer.

11: The manually operated circuit breaker as recited in claim 9, wherein the contact device is configured so as to prevent contact therewith when the electronic control unit is not plugged onto the basic board.

12: The manually operated circuit breaker as recited in claim 9, further comprising an affixing device configured to affix a lead seal to the electronic control unit when the electronic control unit is plugged onto the basic board.

13: The manually operated circuit breaker as recited in claim 9, wherein the tripping element includes an undervoltage tripping function.

14: The manually operated circuit breaker as recited in claim 9, further comprising a blocking device configured to be activated by the manual actuation device and to resist removal of the electronic control unit when the circuit breaker is in an ON position.

15: The manually operated circuit breaker as recited in claim 14, wherein the blocking device includes a blocking mechanism configured to be actuated by the actuating shaft so as to resist and so as to permit a plugging movement of the tripping module.

16: The manually operated circuit breaker as recited in claim 9, wherein the manual actuating device is configured to be lockable.

17: The manually operated circuit breaker as recited in claim 10, wherein the contact device is configured so as to prevent contact therewith when the electronic control unit is not plugged onto the basic board.

18: The manually operated circuit breaker as recited in claim 10, further comprising an affixing device configured to affix a lead seal to the electronic control unit when the electronic control unit is plugged onto the basic board.

19: The manually operated circuit breaker as recited in claim 10, wherein the tripping element includes an undervoltage tripping function.

20: The manually operated circuit breaker as recited in claim 10, further comprising a blocking device configured to be activated by the manual actuation device and to resist removal of the electronic control unit when the circuit breaker is in an ON position.

21: The manually operated circuit breaker as recited in claim 20, wherein the blocking device includes a blocking mechanism configured to be actuated by the actuating shaft so as to resist and so as to permit a plugging movement of the tripping module.

22: The manually operated circuit breaker as recited in claim 10, wherein the manual actuating device is configured to be lockable.

23: The manually operated circuit breaker as recited in claim 15, wherein the manual actuating device is configured to be lockable.

24: The manually operated circuit breaker as recited in claim 21, wherein the manual actuating device is configured to be lockable.
